(19) United States
(12) Patent Application Publication
(10) Pub. No.: US 2009/0119879 A1
(43) Pub. Date: May 14, 2009

(54) Hinge pin

(75) Inventor: Peter E. Rigas, Yardley, PA (US)

Correspondence Address: Deirdra M. Meagher, 24 Mine Street, Flemington, NJ, 08822, US

(73) Assignee: Pleo Originals, LLC

(21) Appl. No.: 12/291,588

(22) Filed: Nov. 12, 2008

Related U.S. Application Data
(63) Continuation-in-part of application No. 11/439,430, filed on May 24, 2006.

(51) Int. Cl. E05D 5/10

(52) U.S. Cl. 16/386

(57) ABSTRACT

A hinge pin for hingedly connecting a first element to a second element, which includes: an elongated shaft having an imaginary central axis along its elongation, and having an upper member, a lower member and a divider stop located between the upper member and the lower member, the upper member having a first maximum width measured at a right angle to the imaginary central axis, the lower member having a second maximum width measured at a right angle to the imaginary central axis, and the divider stop having a third maximum width measured at a right angle to the imaginary central axis, wherein the third maximum width is greater than the second maximum width. In some embodiments, the divider stop is the underside of the upper member.

### REFERENCES TO RELATED APPLICATIONS

This is a continuation-in-part of copending U.S. patent application Ser. No. 11/439,430 filed on May 23, 2006, entitled “Versatile Telescopic Door Hinge Hanger” by the same inventor herein.

### BACKGROUND OF THE INVENTION

1. Field of the Invention

The present invention relates to a hinge pin. The hinge pin includes an upper member, a lower member and a divider stop located between the upper member and the lower member, The divider stop may be part of the upper member or a separate member. A width dimension is measured at a right angle to an elongated shaft composing the pin. The maximum width of the divider stop is greater than the maximum width of the lower member. Thus, the hinge pin is prevented from falling through a hinge. The upper member and the lower member may be different shapes from a top view.

2. Information Disclosure Statement

The following patents relate to the field of hinges:

U.S. Pat. No. 5,505,317 describes a pivoting door hinge held catchall rack including a rod which extends vertically along a plurality of door hinges and which is held by the pins of the door hinges threaded through flanges on either end of the rod and/or through screw-eye type devices which are easily threaded into a slot in back of the rod and therefore can be readily aligned with the tops of the hinges. From the rod are extended, appended, fixed or attached a plurality of catchall, shapes and forms.

U.S. Pat. No. 5,425,462 describes a hinge pin clothes hanger to furnish a quality product made to last, that replaces the hinge pin of any door hinge with a hinge pin clothes hanger that, when properly installed, does not effect the operation of the door or the hinge into which it is being used. The hinge pin clothes hanger is a non-destructive support on which to hang clothes, towels or anything similar, on any door hinge, in any room in which it would be useful. It is easily installed or removed without any damage to the door or hinge. You simply remove the existing hinge pin and install the hinge pin clothes hanger in its place, or simply remove the hinge pin clothes hanger to restore the hinge to its original condition with the original hinge pin. It's that simple. Furthermore, when in use the hinge pin clothes hanger will provide a substantial means of support which will give the consumer years of reliable service and will blend into the décor of the room into which it is being used.

U.S. Pat. No. 5,117,987 discloses a garment support to be detachably mounted upon a door hinge of the type having intermeshing sleeves held together by a hinge pin. The invention comprises a hinge mounting member and a main body member. The hinge mounting member is substantially flat and elongated in shape containing an angled slot at one end capable of receiving the shaft of a hinge pin, and a centered oblong aperture. The main body member is substantially rectangular in shape containing an L-shaped end and a plurality of supports, whereby garments and other articles may be suspended.

U.S. Pat. No. 4,721,212 describes a modular article support unit consisting of an elongated tubular member adapted to be removably attached to the hinge pins of two hinges of a door by means of adjustable brackets, said elongated tubular member having a plurality of holes along the length thereof for removably attaching several types of support devices, such as coat hooks, towel racks, bulletin boards and mirrors.

U.S. Pat. No. 1,208,986 In a device of the character described, the combination of a hinge, an elongated 100 pin carried thereby, and a hook mounted on said pin and provided with a bracing member engaging the hinge.

Notwithstanding the foregoing prior art patents, the present invention is neither taught nor rendered obvious in view of said prior art references.

### SUMMARY OF THE PRESENT INVENTION

The present invention hinge pin for hingedly connecting a first element to a second element includes: an elongated shaft having an imaginary central axis along its elongation, and having an upper member, a lower member and a divider stop located between the upper member and the lower member, the upper member having a first maximum width measured at a right angle to the imaginary central axis, the lower member having a second maximum width measured at a right angle to the imaginary central axis, and the divider stop having a third maximum width measured at a right angle to the imaginary central axis, wherein the third maximum width is greater than the second maximum width.

In some preferred embodiments of the present invention hinge pin for hingedly connecting a first element to a second element, the at least one of the upper member and the lower member has a circular shape from a top view.

In some preferred embodiments of the present invention hinge pin for hingedly connecting a first element to a second element, the divider stop is at least one flange.

In some preferred embodiments of the present invention hinge pin for hingedly connecting a first element to a second element, the at least one flange has a circular shape from a top view.

In some preferred embodiments of the present invention hinge pin for hingedly connecting a first element to a second element, the at least one flange is an arc segment.

In some preferred embodiments of the present invention hinge pin for hingedly connecting a first element to a second element, the at least one flange is a plurality of flanges.

In some preferred embodiments of the present invention hinge pin for hingedly connecting a first element to a second element, one of the upper member and the lower member has a non-circular shape from a top view.

In some preferred embodiments of the present invention hinge pin for hingedly connecting a first element to a second element, the non-circular shape is selected from the group consisting of rectangular, square, triangular, arc shaped and polygonal.

In another embodiment of the present invention, a hinge pin for hingedly connecting a first element to a second element, includes: an elongated shaft having an imaginary central axis along its elongation, and having an upper member, a lower member and a divider stop located between the upper member and the lower member, the upper member having a first maximum width measured at a right angle to the imaginary central axis, the lower member having a second maximum width measured at a right angle to the imaginary central axis, and the divider stop having a third maximum width measured at a right angle to the imaginary central axis, wherein the third maximum width is greater than the second maximum width and wherein the upper member and the lower member have different maximum widths.

In some preferred embodiments of the present invention hinge pin for hingedly connecting a first element to a second element of paragraph [0016], the at least one of the upper member and the lower member has a circular shape from a top view.

In some preferred embodiments of the present invention hinge pin for hingedly connecting a first element to a second element of paragraph [0016], the divider stop is at least one flange.

In some preferred embodiments of the present invention hinge pin for hingedly connecting a first element to a second element of paragraph [0016], the at least one flange has a circular shape from a top view.

In some preferred embodiments of the present invention hinge pin for hingedly connecting a first element to a second element of paragraph [0016], the at least one flange is an arc segment.

In some preferred embodiments of the present invention hinge pin for hingedly connecting a first element to a second element of paragraph [0016], the at least one flange is a plurality of flanges.

In some preferred embodiments of the present invention hinge pin for hingedly connecting a first element to a second element of paragraph [0016], one of the upper member and the lower member has a non-circular shape from a top view.

In some preferred embodiments of the present invention hinge pin for hingedly connecting a first element to a second element of paragraph [0016], the non-circular shape is selected from the group consisting of rectangular, square, triangular, arc shaped and polygonal.

In another embodiment of the present invention, a hinge pin for hingedly connecting a first element to a second element includes: an elongated shaft having an imaginary central axis along its elongation, and having an upper member and a lower member, the upper member including a divider stop wherein said divider stop is the underside of said upper member, said upper member having a first maximum width measured at a right angle to said imaginary central axis, said lower member having a second maximum width measured at a right angle to said imaginary central axis, wherein said first maximum width is greater than said second maximum width.

In some preferred embodiments of the present invention hinge pin for hingedly connecting a first element to a second element of paragraph [0024], at least one of the upper member and the lower member has a circular shape from a top view.

In some preferred embodiments of the present invention hinge pin for hingedly connecting a first element to a second element of paragraph [0024], both of the upper member and the lower member have circular shapes from a top view.

In some preferred embodiments of the present invention hinge pin for hingedly connecting a first element to a second element of paragraph [0024], one of the upper member and the lower member has a non-circular shape from a top view.

### BRIEF DESCRIPTION OF THE DRAWINGS

The present invention should be more fully understood when the specification herein is taken in conjunction with the drawings appended hereto wherein:

FIG. 1 illustrates a side view of one preferred embodiment of the present invention hinge pin showing the hinge pin in use connected to a hanger device;

FIGS. 2, 3 and 4 illustrate closed exploded side view, closed pin-mounted side view and closed pin-mounted end view, respectively, of the present invention hinge pin shown in FIG. 1 above;

FIGS. 5, 6 and 7 illustrate a front view, a top view and a bottom view, respectively, of the present invention hinge pin shown in FIG. 1 above;

FIGS. 8 and 9 illustrate a top view and a bottom view, respectively, of another embodiment of a present invention hinge pin.

FIGS. 10 and 11 illustrate a top view, and a front view, respectively, of another embodiment of a present invention hinge pin;

FIG. 12 illustrates a front view of a present invention two member hinge pin; and,

FIG. 13 is a schematic of a present invention two member hinge pin.

### DETAILED DESCRIPTION OF THE PRESENT INVENTION

The present invention relates to a hinge pin. The hinge pin includes an upper member, a lower member and a divider stop located between the upper member and the lower member. The divider stop may be part of the upper member or a separate member. A width dimension is measured at a right angle to an elongated shaft composing the pin. The maximum width of the divider stop is greater than the maximum width of the lower member. Thus, the hinge pin is prevented from falling through a hinge. The upper member and the lower member may be different shapes from a top view.

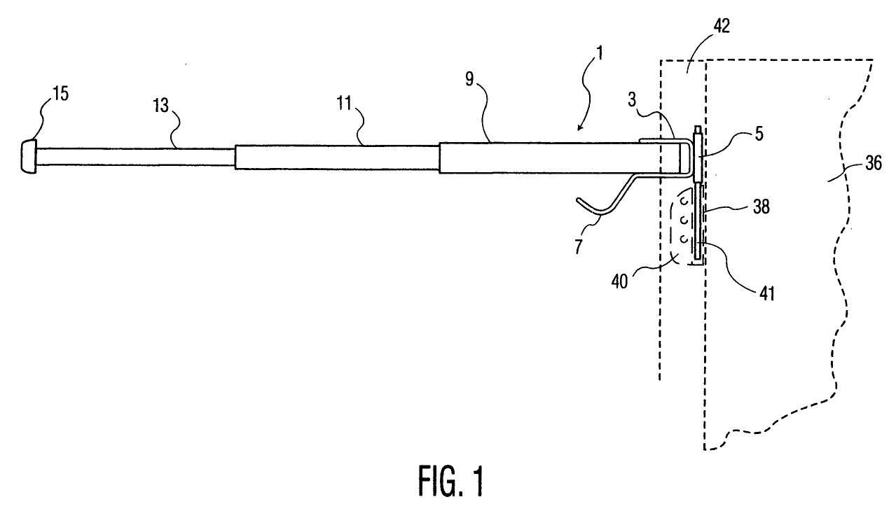

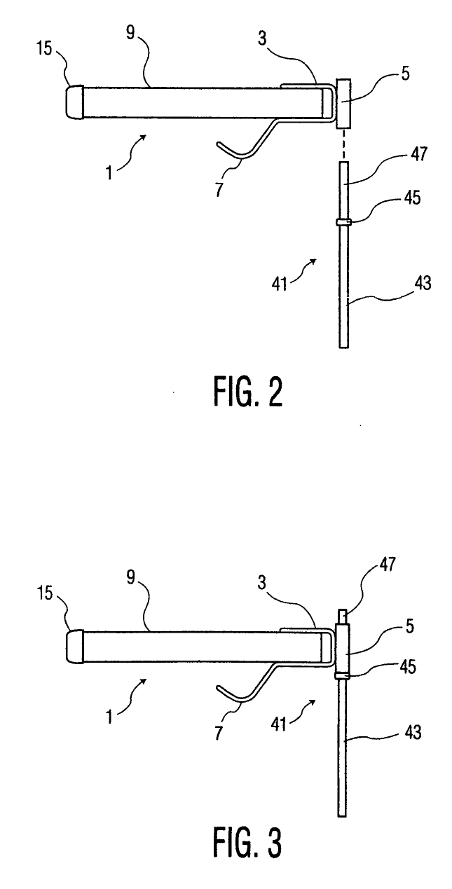

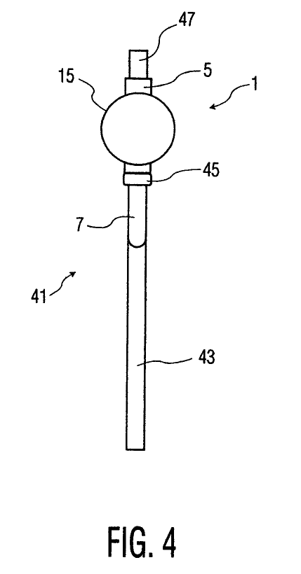

The present invention hinge pin is shown in FIG. 1, which illustrates a side view of one preferred embodiment of the present invention hinge pin in use connected to a hanger device 1, in its mounted, fully extended position for hanging towels and or wet clothes, dry clothes and the like thereon. The hanger device 1 includes a brace member 3 with a hollow vertical shaft 5 for attachment to a pin or hinge pin, in this case, present invention extension pin 41. Brace member 3 has an optional hook 7 extending from its bottom. Brace 3 is connected (welded) to a main support member 9. Main support member 9 is a hollow oval tube with an inwardly turned flange (acting as a stop) at its end opposite brace member 3 and has secondary support member 11 fitted inside it so as to be telescopically and slideably mounted therein. Secondary support member 11 has an outwardly extending flange at its end inside main support member 9 and an outwardly extending flange at its opposite end. A second secondary support member 13 is fitted inside secondary support member 11 and appropriate stop flanges are included. There is a bumper 15 at the distal end of secondary support member 13 and hence at the distal end of the hanger 1. This bumper 15 is optional, but is a beneficial safety device that may reduce or prevent accidental injury or damage. Door 36 is connected to door jamb 42 via a plurality of hinges (“hinges” used herein means complimentary hinge plates with or without the pin, depending upon the context), such as hinge 40. The conventional pin of hinge 40 has been removed and present invention extension pin 41 has been put in its place in the hollow shafts 38 of hinge 40. The pin 41 makes up an elongated shaft and has an imaginary central axis along its elongation. This pin 41 has an upper section that extends above the hinge 40 to receive the shaft 5 of the hanger 1. Details of the present invention hinge pin are shown in conjunction with the next three FIGS. 2 through 4.

FIGS. 2, 3 and 4 illustrate closed exploded side view, closed pin-mounted side view and closed pin-mounted end view, respectively, of the present invention hinge pin 41 connected to a hanger device 1 shown in FIG. 1 above. Identical parts are identically numbered. Here, the details are shown as to the pin 41. It has a lower section 43 for inserting into a door hinge, an upper section 47 for receiving the present invention hanger brace shaft 5, and a flange 45 that acts as a stop to prevent the pin 41 from falling through a hinge or falling low enough to be ineffective for mounting of hanger 1. The flange 45 is a divider stopper located between the upper member and the lower member. The pin 41 or other extension pin is preferred over a conventional pin. A conventional pin would be removed from a door hinge, the shaft 5 positioned atop the hinge and the pin reinserted first through shaft 5 and then into the hinge shafts. Two disadvantages occur. First, the conventional pin would not necessarily extend though all shaft sections of its hinge, and, second, the hanger 1 would not be easily portable, as the pin would have to be removed each time the hanger 1 was to be removed. Thus, the present invention extension pin 41 overcomes both of these shortcomings by providing the added capless extension upper section for extremely easy mounting and moving of the hanger 1 onto and off the pin.

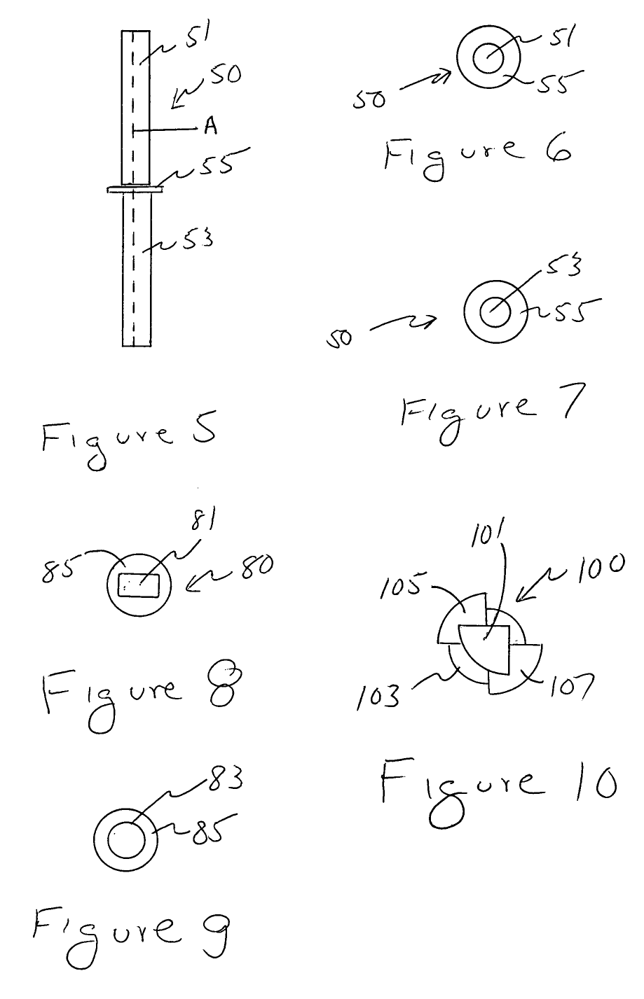

FIGS. 5, 6 and 7 illustrate a front view, a top view and a bottom view, respectively, of the present invention hinge pin 50 shown in FIG. 1 above. The hinge pin 50 includes an elongated shaft having an imaginary central axis A along its elongation. In addition, the hinge pin 50 includes an upper member 51, a lower member 53 and a divider stop 55 located between the upper member 51 and the lower member 53. In this case, the upper member 51 and the lower member 53 have a circular shape from a top view. The divider stop 55, in this case a flange, has a circular shape from a top view. The upper member 51 has a first maximum width measured at a right angle to the imaginary central axis A. The lower member 53 has a second maximum width measured at a right angle to the imaginary central axis A. The divider stop 55 has a third maximum width measured at a right angle to the imaginary central axis A. As shown, the third maximum width is greater than second maximum width while the first maximum width and the second maximum width are the same.

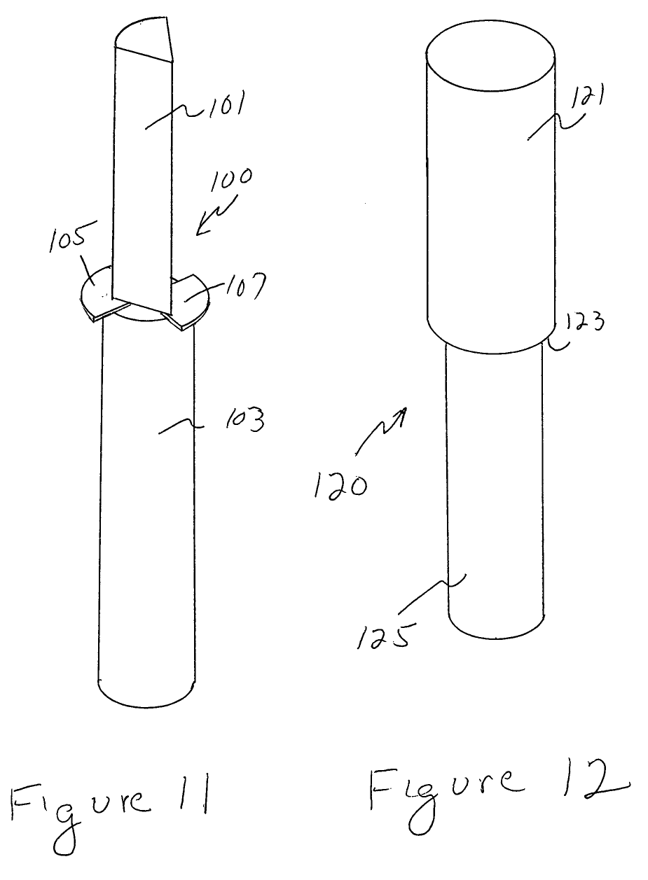

FIGS. 8 and 9 illustrate a top view and a bottom view, respectively, of another embodiment of a present invention hinge pin 80. In this case, an upper member 81 and a lower member 83 have different shapes from a top view. The upper member 81 is rectangular shaped while the lower member 83 is circular shaped. A divider stop 85, in this case a flange, has a circular shape from a top view. The upper member 81 has a first maximum width measured at a right angle to the imaginary central axis. The lower member 83 has a second maximum width measured at a right angle to the imaginary central axis. The divider stop 85 has a third maximum width measured at a right angle to the imaginary central axis. As shown, the third maximum width is greater than second maximum width while the first maximum width and the second maximum width are the same.

FIGS. 10 and 11 illustrate a top view, and a front view, respectively, of another embodiment of a present invention hinge pin 100. In this case, an upper member 101 and a lower member 103 have different shapes from a top view. The upper member 101 is a pie shaped arc segment while the lower member 103 is circular shaped. A divider stop, in this case a plurality of flanges 105 and 107, in which each flange is a cut-out arc segment from a top view is located between the upper member 101 and the lower member 103. The upper member 101 has a first maximum width measured at a right angle to the imaginary central axis. The lower member 103 has a second maximum width measured at a right angle to the imaginary central axis. The divider stop 105 and 107 has a third maximum width measured at a right angle to the imaginary central axis where the maximum width of each divider stop 105 and 107 is combined to give the third maximum width. As shown, the third maximum width is greater than second maximum width while the first maximum width is less than the second maximum width.

FIG. 12 illustrates a front view of a present invention two member hinge pin 120. In this case, an upper member 121 and a lower member 125 are both circular shaped from a top view. However, a divider stop 123 is the underside of the upper member 121. The upper member 121 has a first maximum width measured at a right angle to the imaginary central axis. The lower member 125 has a second maximum width measured at a right angle to the imaginary central axis. As shown, the first maximum width is greater than second maximum. The divider stop 123 prevents the hinge pin 120 from falling through a hinge.

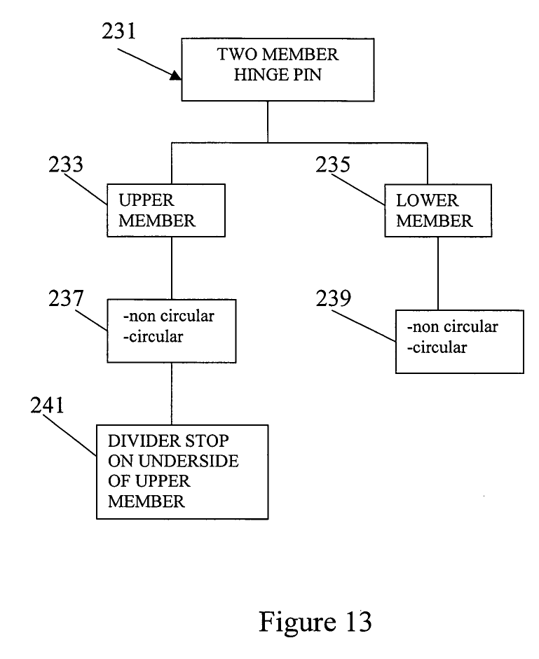

FIG. 13 is a schematic of a present invention two member hinge pin 231. The hinge pin 231 includes an upper member 233 and a lower member 235. The upper member 233 may be circular in shape from a top view or non circular in shape from a top view 237. The lower member 235 may be circular in shape from a top view or non circular in shape from a top view 239. A divider stop 241 is on an underside of the upper member 233.

Numerous modifications and variations of the present invention are possible in light of the above teachings. It is therefore understood that within the scope of the appended claims, the invention may be practiced otherwise than as specifically described herein.

What is claimed is:

1. A hinge pin for hingedly connecting a first element to a second element, which consists of:
an elongated shaft having an imaginary central axis along its elongation, and having an upper member, a lower member and a divider stop located between said upper member and said lower member, said upper member having a first maximum width measured at a right angle to said imaginary central axis, said lower member having a second maximum width measured at a right angle to said imaginary central axis, and said divider stop having a third maximum width measured at a right angle to said imaginary central axis, wherein said third maximum width is greater than said second maximum width.

2. The hinge pin for hingedly connecting a first element to a second element of claim 1 wherein at least one of said upper member and said lower member has a circular shape from a top view.

3. The hinge pin for hingedly connecting a first element to a second element of claim 1 wherein said divider stop is at least one flange.

4. The hinge pin for hingedly connecting a first element to a second element of claim 3 wherein said at least one flange has a circular shape from a top view.

5. The hinge pin for hingedly connecting a first element to a second element of claim 3 wherein said at least one flange is an arc segment.

6. The hinge pin for hingedly connecting a first element to a second element of claim 3 wherein said at least one flange is a plurality of flanges.

7. The hinge pin for hingedly connecting a first element to a second element of claim 1 wherein one of said upper member and said lower member has a non-circular shape from a top view.

8. The hinge pin for hingedly connecting a first element to a second element of claim 7 wherein said non-circular shape is selected from the group consisting of rectangular, square, triangular, arc shaped and polygonal.

9. A hinge pin for hingedly connecting a first element to a second element, which consists of:
an elongated shaft having an imaginary central axis along its elongation, and having an upper member, a lower member and a divider stop located between said upper member and said lower member, said upper member having a first maximum width measured at a right angle to said imaginary central axis, said lower member having a second maximum width measured at a right angle to said imaginary central axis, and said divider stop having a third maximum width measured at a right angle to said imaginary central axis, wherein said third maximum width is greater than said second maximum width and wherein said upper member and said lower member have different maximum widths.

10. The hinge pin for hingedly connecting a first element to a second element of claim 9 wherein at least one of said upper member and said lower member has a circular shape from a top view.

11. The hinge pin for hingedly connecting a first element to a second element of claim 9 wherein said divider stop is at least one flange.

12. The hinge pin for hingedly connecting a first element to a second element of claim 11 wherein said at least one flange has a circular shape from a top view.

13. The hinge pin for hingedly connecting a first element to a second element of claim 11 wherein said at least one flange is an arc segment.

14. The hinge pin for hingedly connecting a first element to a second element of claim 11 wherein said at least one flange is a plurality of flanges.

15. The hinge pin for hingedly connecting a first element to a second element of claim 9 wherein one of said upper member and said lower member has a non-circular shape from a top view.

16. The hinge pin for hingedly connecting a first element to a second element of claim 15 wherein said non-circular shape is selected from the group consisting of rectangular, square, triangular, arc shaped and polygonal.

17. A hinge pin for hingedly connecting a first element to a second element, which consists of:
an elongated shaft having an imaginary central axis along its elongation, and having an upper member and a lower member, said upper member including a divider stop wherein said divider stop is the underside of said upper member, said upper member having a first maximum width measured at a right angle to said imaginary central axis, said lower member having a second maximum width measured at a right angle to said imaginary central axis, wherein said first maximum width is greater than said second maximum width.

18. The hinge pin for hingedly connecting a first element to a second element of claim 17 wherein at least one of said upper member and said lower member has a circular shape from a top view.

19. The hinge pin for hingedly connecting a first element to a second element of claim 17 wherein both of said upper member and said lower member have circular shapes from a top view.

20. The hinge pin for hingedly connecting a first element to a second element of claim 17 wherein one of said upper member and said lower member has a non-circular shape from a top view.
